(19) United States
(12) Patent Application Publication
(10) Pub. No.: US 2016/0246484 A1
(43) Pub. Date: Aug. 25, 2016

(54) ELECTRONIC DEVICE AND METHOD FOR CONTROLLING OF THE SAME

(71) Applicant: LG ELECTRONICS INC., Seoul (KR)

(72) Inventors: Jaewoon KIM, Seoul (KR); Kyueun YI, Seoul (KR)

(73) Assignee: LG ELECTRONICS INC., Seoul (KR)

(21) Appl. No.: 15/028,215

(22) PCT Filed: Nov. 8, 2013
(86) PCT No.: PCT/KR2013/010127

§ 371 Date: Apr. 8, 2016

(51) Int. Cl. G06F 3/0484; G06F 3/0482; G06F 3/0488; G06F 3/0481

(52) U.S. Cl. CPC G06F 3/04842; G06F 3/04845; G06F 3/04817; G06F 3/0482; G06F 3/04883

(57) ABSTRACT

Disclosed are an electronic device and a method for controlling the same. The electronic device includes: a display: and a controller configured to select at least one clipping region from an execution screen having at least one application, configured to extract at least one clipping contents from the at least one clipping region and location information of the at least one clipping region, configured to generate at least one item corresponding to the at least one clipping contents, and configured to display the at least one item on a specific region of the display.

### TECHNICAL FIELD

The present invention relates to an electronic device to manage clipping contents selected from an execution screen with a plurality of applications as one application and a method for controlling the same.

### BACKGROUND ART

In recent years, an electronic device such as a smart phone has provided various multi-media services such as data communication, a camera, a DMB, playback of a moving image, and a short message service (SMS) as well as a voice call function.

The electronic device may be classified into a mobile electronic device and a fixed electronic device according to moving possibility. The mobile electronic device may be classified into a portable type electronic device and a stationary type electronic device according to whether a user directly carries the mobile electronic device.

In order to support and increase functions of the electronic device, improvement with respect to a structural part and/or a software part may be considered. As various electronic devices provide various complicated functions, user interface is increasingly complicated. The user interface has been developed so that a user may easily access various functions of electronic devices and the user interface may satisfy the user's sensibility.

In particular, as a structure of the electronic device is diversified, there is a demand for development to suitably provide user interface suited to a use state of a corresponding electronic device by taking a use state of an electronic having a specific construction and/or function.

### DISCLOSURE OF INVENTION

### Technical Problem

The prevent invention has been made in an effort to solve the above-described problems, and an object of the present invention is to provide an electronic device to integrally manage a plurality of clipping contents selected from an execution screen with a plurality of applications, to display the clipping contents on a specific region of a display, and to execute a shortcut to a clipping region corresponding to the clipping contents, and a method for controlling the same.

### Solution to Problem

In order to accomplish the above objects of the present invention, there is provided an electronic device including: a display: and a controller configured to select at least one clipping region from an execution screen having at least one application, configured to extract at least one clipping contents from the at least one clipping region and location information of the at least one clipping region, configured to generate at least one item corresponding to the at least one clipping contents, and configured to display the at least one item on a specific region of the display.

The controller may display at least one item corresponding to the at least one clipping contents when receiving a first input with respect to the specific region, and releases display of at least one time corresponding to the at least one clipping contents when receiving a second input with respect to the specific region.

The controller may display at least one item corresponding to the at least one clipping contents to be overlapped with the specific region on an execution screen of a specific application when the execution screen of the specific application is displayed on the display.

The controller may designate the specific region of the display as a bay-type region formed based on a corner of the display.

The controller may move at least one item corresponding to the at least one clipping contents to a left side or a right side, and displays at least one item corresponding to the at least one clipping contents which are not displayed on the specific region of the display on the specific region of the display when receiving a left or right movement input with respect to at least one item corresponding the at least one clipping contents displayed on the specific region of the display.

The at least one item corresponding to the at least one clipping contents may include at least one of clipping contents, thumbnail information, key contents among the at least one clipping contents, and an icon of an application selecting the at least one clipping contents.

The controller may enlarge and display the specific clipping contents as a pop-up window when receiving a first input with respect to a specific item corresponding to specific clipping contents among at least one item corresponding to the at least clipping contents.

The controller may perform a shortcut to an execution screen of a specific application corresponding to location information of a specific clipping region including the specific clipping contents, displays the execution screen of the specific application on the display, and displays an indicator on the specific clipping region of the execution screen of the application when receiving a second input with respect to the pop-up window.

The controller may enlarges and display latest selected clipping contents among clipping contents associated with the specific application when receiving a first input with respect to an icon associated with a specific application among at least one item corresponding to the at least one clipping contents.

The controller may reduce a plurality of clipping contents associated with the specific application to display the reduced clipping contents when receiving a second input with respect to the pop-up window.

The controller may perform a shortcut to an execution screen of a specific application corresponding to location information of a specific clipping region including a latest selected clipping contents among clipping contents associated with the specific application to display the execution screen of the specific application on the display, and displays an indicator on the specific clipping region of the execution screen of the specific application when receiving a first input with respect to an icon associate with a specific application among at least one item corresponding to the at least one clipping contents.

The controller may automatically execute an application to manage the at least one clipping contents when receiving an input to select the at least one clipping region during execution of the at least one application.

The controller may highlight and display main contents among the specific clipping contents when specific contents included in specific clipping contents are set as the main contents.

The controller may display a used history with respect to at least one item corresponding to the at least one clipping contents as an indicator when another application uses the at least one clipping contents.

The controller may automatically set the specific region of the display according to a touch track.

The controller may filter the at least one clipping contents according to a type of specific application and displays an item corresponding to the filtered clipping contents on the specific region of the display when the specific application is executed.

There is provided an electronic device including: a display: and a controller configured to store at least one of clipping contents included in a at least one clipping region selected from an execution screen with at least one application, location information of the at least one clipping region, and at least one item corresponding to the at least one clipping contents, configured to filter the at least one stored clipping contents with a preset reference according to a specific application when the specific application is executed, and configured to display an item corresponding to the filtered clipping contents on a specific region of the display when an input item is included in the execution screen of the specific application.

The controller may execute copy and paste functions with respect to the filtered clipping contents upon selection of the filtered clipping contents when the input item of the execution screen of the specific application is edited.

There is provided a method for controlling an electronic device, the method including: selecting at least one clipping region from an execution screen of a specific application; extracting at least one clipping contents included in the at least one clipping region and location information of the at least one clipping region through an application to manage at least one clipping contents included in the at least one clipping to generate at least one item corresponding to the at least one clipping contents when receiving an input to select the at least one clipping region during execution of the specific application; and displaying the generated at least one item to be overlapped with a specific region of the execution screen of the specific application.

There is provided a method for controlling an electronic device, the method including: storing at least one clipping contents included in at least one clipping region selected from an execution screen with at least one application, location information of the at least one clipping region, and at least one item corresponding to the at least one clipping contents through a first application; filtering the at least stored clipping contents according to a type of the second application by executing the first application as a back-ground when receiving an execution request of a second application; and switching an execution screen of the first application to a fore-ground and displaying an item corresponding to the filtered clipping contents on a specific region when an input item is included in an execution screen of the second application.

The details of other embodiments are contained in the detailed description and accompanying drawings.

### Advantageous Effects of Invention

The electronic device and the method of controlling the same according to the embodiment have following effects.

According to the embodiment, clipping contents selected from a plurality of applications can be integrally managed and may be confirmed on an execution screen together with clipping contents by selecting and integrally managing a region including desired contents of a user. According to the embodiment, when receiving a specific input with respect to the clipping contents, the shortcut to a clipping region of the execution screen of the specific application can be executed.

In addition, according to the embodiment, the clipping contents can be automatically filtered or arranged according to the type of a specific application and convenience for the user can be improved by providing filtered or arranged clipping contents upon edition of an input item of the specific application.

### BRIEF DESCRIPTION OF DRAWINGS

FIG. 1 is a block diagram of an electronic device according to an embodiment.

FIG. 2A is a front perspective view of the electronic device according to an embodiment.

FIG. 2B is a rear perspective view of the electronic device according to an embodiment.

FIG. 3 is a flowchart illustrating a method for controlling an electronic device according to a first embodiment.

FIGS. 4A to 4D are diagrams illustrating a method for selecting a clipping region in an electronic device according to a first embodiment.

FIGS. 5A to 5D are diagrams illustrating a method for selecting main contents from the clipping region in an electronic device according to a first embodiment.

FIGS. 6A to 6D are diagrams illustrating a method for displaying an item corresponding to clipping contents in an electronic device according to a first embodiment.

FIGS. 7 and 8 are diagrams illustrating a method for displaying a plurality of clipping contents in an electronic device according to a first embodiment.

FIGS. 9 and 10 are diagrams illustrating a method for switching an execution screen of an application to manage clipping contents to a back-ground or a fore-ground in an electronic device according to a first embodiment.

FIG. 11 is a diagram illustrating a method for designating a specific region in an electronic device according to a first embodiment.

FIGS. 12 to 15 are diagrams illustrating a method for previously confirming clipping contents in an electronic device according to a first embodiment.

FIGS. 16 and 17 are diagrams illustrating a method for executing a shortcut to a clipping region corresponding to clipping contents in an electronic device according to a first embodiment.

FIGS. 18A to 18D are diagrams illustrating a method for displaying a used history of clipping contents in an electronic device according to a first embodiment.

FIG. 19 is a diagram illustrating a method for controlling an electronic device according to a second embodiment.

FIG. 20 is a diagram illustrating a method for displaying clipping contents filtered by the electronic device according to a second embodiment.

FIG. 21 is a diagram illustrating a method for adding at least some of clipping contents filtered by the electronic device according to a second embodiment.

### MODE FOR THE INVENTION

Embodiments of the present invention may relate to a device and a call providing method thereof that substantially obviates one or more problems due to limitations and disadvantages of related art.

Embodiments of the present invention may provide a device and a call providing method thereof, in which a video call communication or a voice call communication may not be selected in a manner that a calling device transmits both a video call and a voice call to a called device.

Embodiments of the present invention may provide a device and a call providing method thereof, by which a called device is enabled to determine whether to make a video communication or a voice communication with a calling device.

A device may be provided that includes a controller. If a user selects contact information, the controller may generate a message for transmitting both a video call and a voice call to the selected contact information. The device may also include a wireless communication unit to transmit the generated message to a called device that matches the selected contact information.

A method may also be provided in a device. The method may include selecting at least one contact information, generating a message for transmitting both a video call and a voice call to the selected contact information, and transmitting the message to a called device that matches the selected contact information.

A device may be provided that includes a wireless communication module to receive a message including a video call and a voice call from a calling device. A display module may display information indicating that the video call and the voice call are received. If either the video call or the voice call is selected, a controller may perform an operation for connection and communication of the selected call by controlling the wireless communication unit.

A method may also be provided in a device. The method may include receiving a message including a video call and a voice call from a calling device, and displaying information identifying that the video call and the voice call are received. The method may also include performing an operation for connection and communication of the selected call if either the video call or the voice call is selected.

The suffixes ‘module’, ‘unit’ and ‘part’ may be used for elements in order to facilitate the disclosure. Significant meanings or roles may not be given to the suffixes themselves and it is understood that the ‘module’, ‘unit’ and ‘part’ may be used together or interchangeably.

Embodiments of the present invention may be applicable to various types of devices.

Examples of such devices may include mobile devices as well as stationary devices, such as mobile phones, user equipment, smart phones, DTV, computers, digital broadcast devices, personal digital assistants, portable multimedia players (PMP) and/or navigators.

A further description may be provided with regard to a mobile device, although such teachings may apply equally to other types of devices.

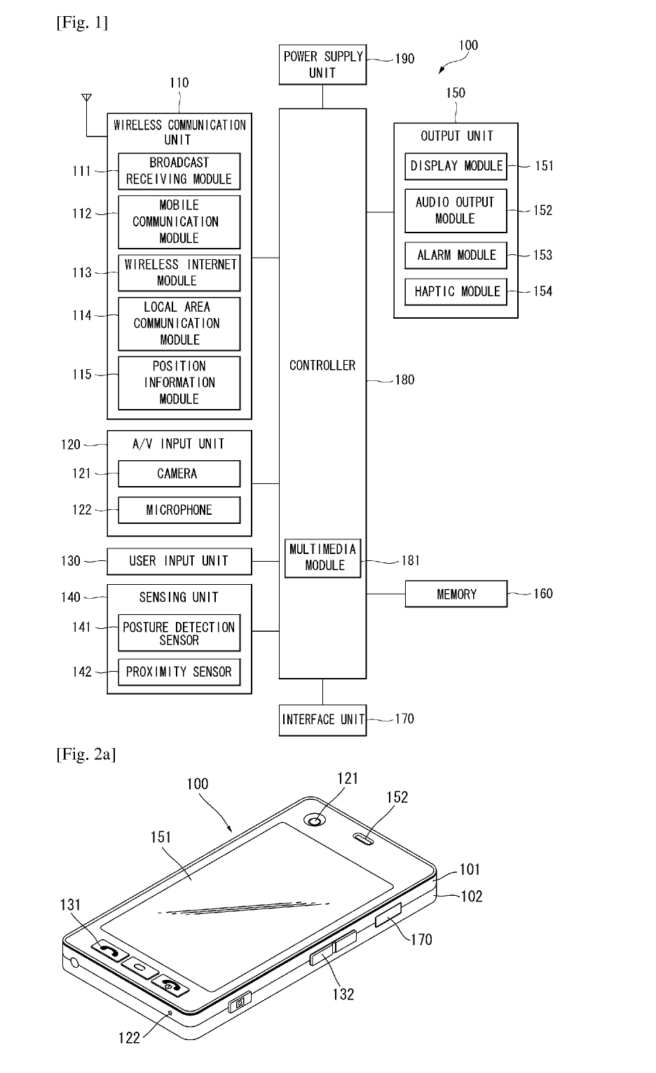

FIG. 1 is a block diagram of a mobile device in accordance with an example embodiment. Other embodiments and arrangements may also be provided. FIG. 1 shows a mobile device 100 having various components, although other components may also be used. More or less components may alternatively be implemented.

FIG. 1 shows that the mobile device 100 includes a wireless communication unit 110, an audio/video (A/V) input unit 120, a user input unit 130, a sensing unit 140, an output unit 150, a memory 160, an interface unit 170, a controller 180 and a power supply 190.

The wireless communication unit 110 may be configured with several components and/or modules. The wireless communication unit 110 may include a broadcast receiving module 111, a mobile communication module 112, a wireless Internet module 113, a short-range communication module 114 and a position-location module 115. The wireless communication unit 110 may include one or more components that permit wireless communication between the mobile device 100 and a wireless communication system or a network within which the mobile device 100 is located. In case of non-mobile devices, the wireless communication unit 110 may be replaced with a wire communication unit. The wireless communication unit 110 and the wire communication unit may be commonly referred to as a communication unit.

The broadcast receiving module 111 may receive a broadcast signal and/or broadcast associated information from an external broadcast managing entity via a broadcast channel. The broadcast channel may include a satellite channel and a terrestrial channel. The broadcast managing entity may refer to a system that transmits a broadcast signal and/or broadcast associated information.

At least two broadcast receiving modules 111 may be provided in the mobile device 100 to pursue simultaneous reception of at least two broadcast channels or facilitation of broadcast channel switching.

Examples of broadcast associated information may include information associated with a broadcast channel, a broadcast program, a broadcast service provider, etc. For example, broadcast associated information may include an electronic program guide (EPG) of digital multimedia broadcasting (DMB) and an electronic service guide (ESG) of digital video broadcast-handheld (DVB-H).

The broadcast signal may be a TV broadcast signal, a radio broadcast signal, and/or a data broadcast signal. The broadcast signal may further include a broadcast signal combined with a TV or radio broadcast signal.

The broadcast receiving module 111 may receive broadcast signals transmitted from various types of broadcast systems. As a non-limiting example, the broadcasting systems may include digital multimedia broadcasting-terrestrial (DMB-T), digital multimedia broadcasting-satellite (DMB-S), digital video broadcast-handheld (DVB-H), a data broadcasting system known as media forward link only (MediaFLO®) and integrated services digital broadcast-terrestrial (ISDB-T). The receiving of multicast signals may also be provided. Data received by the broadcast receiving module 111 may be stored in the memory 160, for example.

The mobile communication module 112 may communicate wireless signals with one or more network entities (e.g. a base station or Node-B). The signals may represent audio, video, multimedia, control signaling, and data, etc.

The wireless Internet module 113 may support Internet access for the mobile device 100. This wireless Internet module 113 may be internally or externally coupled to the mobile device 100. Suitable technologies for wireless Internet may include, but are not limited to, WLAN (Wireless LAN) (Wi-Fi), Wibro (Wireless broadband), Wimax (World Interoperability for Microwave Access), and/or HSDPA (High Speed Downlink Packet Access). The wireless Internet module 113 may be replaced with a wire Internet module in non-mobile devices. The wireless Internet module 113 and the wire Internet module may be referred to as an Internet module.

The short-range communication module 114 may facilitate short-range communications. Suitable technologies for short-range communication may include, but are not limited to, radio frequency identification (RFID), infrared data association (IrDA), ultra-wideband (UWB), as well as networking technologies such as Bluetooth and ZigBee.

The position-location module 115 may identify or otherwise obtain a location of the mobile device 100. The position-location module 115 may be provided using global positioning system (GPS) components that cooperate with associated satellites, network components, and/or combinations thereof.

The position-location module 115 may precisely calculate current 3-dimensional position information based on longitude, latitude and altitude by calculating distance information and precise time information from at least three satellites and then by applying triangulation to the calculated information. Location and time information may be calculated using three satellites, and errors of the calculated location position and time information may then be amended or changed using another satellite. The position-location module 115 may calculate speed information by continuously calculating a real-time current location.

The audio/video (A/V) input unit 120 may provide audio or video signal input to the mobile device 100. The A/V input unit 120 may include a camera 121 and a microphone 122. The camera 121 may receive and process image frames of still screens and/or video.

The microphone 122 may receive an external audio signal while the mobile device is in a particular mode, such as a phone call mode, a recording mode and/or a voice recognition mode. The received audio signal may then be processed and converted into digital data.

The mobile device 100, and in particular the A/V input unit 120, may include a noise removing algorithm (or noise canceling algorithm) to remove noise generated in the course of receiving the external audio signal. Data generated by the A/V input unit 120 may be stored in the memory 160, utilized by the output unit 150, and/or transmitted via one or more modules of the wireless communication unit 110. Two or more microphones and/or cameras may also be provided.

The user input unit 130 may generate input data responsive to user manipulation of an associated input device or devices. Examples of such devices may include a keypad, a dome switch, a touchpad (e.g., static pressure/capacitance), a jog wheel and/or a jog switch. A specific example is one in which the user input unit 130 is configured as a touchpad in cooperation with a display, as will be described below.

The sensing unit 140 may provide status measurements of various aspects of the mobile device 100. For example, the sensing unit 140 may detect an open/close status (or state) of the mobile device 100, a relative positioning of components (e.g., a display and a keypad) of the mobile device 100, a change of position of the mobile device 100 or a component of the mobile device 100, a presence or absence of user contact with the mobile device 100, and/or an orientation or acceleration/deceleration of the mobile device 100.

The mobile device 100 may be configured as a slide-type mobile device. In such a configuration, the sensing unit 140 may sense whether a sliding portion of the mobile device 100 is open or closed. The sensing unit 140 may also sense presence or absence of power provided by the power supply 190, presence or absence of a coupling or other connection between the interface unit 170 and an external device, etc.

The sensing unit 140 may include a proximity sensor 141, a motion detecting sensor 142, a brightness detecting sensor 143, a distance detecting sensor 144, and/or a heat detecting sensor 145. Details of the proximity sensor 141 and the other sensors 142, 143, 144 and 145 may be explained below.

The motion detecting sensor 142 may detect a motion state of the mobile device 100 by an external force such as an external shock, an external vibration and/or the like. The motion detecting sensor 142 may detect a motion extent. The motion detecting sensor 142 may be provided with a rotational body and detect a motion of the device by detecting a property of a mechanical movement of the rotational body. Based on speed, acceleration and direction of the motion, the motion detecting sensor 142 may detect either the motion extent or a motion pattern and then output the detected one to the controller 180. The motion detecting sensor 142 may include a gyro sensor.

The brightness detecting sensor 143 may detect a brightness of light around the mobile device 100 and then output the detected brightness to the controller 180.

The distance detecting sensor 144 may include an ultrasonic sensor or the like. The distance detecting sensor 144 may measure a distance between the mobile device 100 and a user and then output the detected distance to the controller 180.

The heat detecting sensor 145 may be provided around the display 151 of the device body. The heat detecting sensor 145 may detect the temperature on user's contact with the device body and then output the detected temperature to the controller 180.

The output unit 150 may generate an output relevant to a sight sense, an auditory sense, a tactile sense and/or the like. The output unit 150 may include a display 151, an audio output module 152, an alarm 153, a haptic module 154 and/or the like.

The display 151 may display (output) information processed by the device 100. For example, in case that the device is in a call mode, the display 151 may display a user interface (UI) or a graphic user interface (GUI) associated with the call. If the mobile device 100 is in a video communication mode or a photograph mode, the display 151 may display a photographed and/or received screen, a UI or a GUI.

The display 151 may include at least one of a liquid crystal display (LCD), a thin film transistor liquid crystal display (TFT LCD), an organic light-emitting diode (OLED), a flexible display, and a 3-dimensional display.

The display 151 may have a transparent or light-transmittive type configuration to enable an external environment to be seen through. This may be called a transparent display. A transparent OLED (TOLED) may be an example of a transparent display. A backside structure of the display 151 may also have the light-transmittive type configuration. In this configuration, a user may see an object located behind the device body through the area occupied by the display 151 of the device body.

At least two displays 151 may also be provided. For example, a plurality of displays may be provided on a single face of the device 100 by being built in one body or spaced apart from the single face. Alternatively, each of a plurality of displays may be provided on different faces of the device 100.

If the display 151 and a sensor for detecting a touch action (hereafter a touch sensor) are constructed in a mutual-layered structure (hereafter a touchscreen), the display 151 may be used as an input device as well as an output device. For example, the touch sensor may include a touch film, a touch sheet, a touchpad and/or the like.

The touch sensor may convert a pressure applied to a specific portion of the display 151 or a variation of electrostatic capacity generated from a specific portion of the display 151 to an electric input signal. The touch sensor may detect a pressure of a touch as well as a position and size of the touch.

If a touch input is provided to the touch sensor, signal(s) corresponding to the touch input may be transferred to a touch controller. The touch controller may process the signal(s) and then transfer corresponding data to the controller 180. The controller 180 may therefore know which portion of the display 151 is touched.

FIG. 1 shows that the proximity sensor 141 can be provided within the mobile device 100 enclosed by the touchscreen or around the touchscreen. The proximity sensor 141 may detect a presence or non-presence of an object approaching a prescribed detecting surface or an object existing around the proximity sensor 141 using an electromagnetic field strength or infrared ray without mechanical contact. The proximity sensor 141 may have a longer durability than the contact type sensor and may also have a greater usage than the contact type sensor.

The proximity sensor 141 may include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and/or the like. If the touchscreen is an electrostatic type, the proximity sensor 141 may detect proximity of a pointer using a variation of an electric field according to the proximity of the pointer. In this case, the touchscreen (touch sensor) may be classified into the proximity sensor.

An action in which a pointer approaches the touchscreen without contacting the touchscreen may be called a proximity touch. An action in which a pointer actually touches the touchscreen may be called a contact touch. The location of the touchscreen proximity-touched by the pointer may be the position of the pointer that vertically opposes the touchscreen when the pointer performs the proximity touch.

The proximity sensor 141 may detect a proximity touch and/or a proximity touch pattern (e.g., a proximity touch distance, a proximity touch duration, a proximity touch position, a proximity touch shift state, etc.). Information corresponding to the detected proximity touch action and/or the detected proximity touch pattern may be outputted to the touchscreen.

The audio output module 152 may output audio data that is received from the wireless communication unit 110 in a call signal reception mode, a call mode, a recording mode, a voice recognition mode, a broadcast receiving mode and/or the like. The audio output module 152 may output audio data stored in the memory 160. The audio output module 152 may output an audio signal relevant to a function (e.g., a call signal receiving sound, a message receiving sound, etc.) performed by the mobile device 100. The audio output module 152 may include a receiver, a speaker, a buzzer and/or the like.

The alarm 153 may output a signal for announcing an event occurrence of the mobile device 100. An event occurring in the mobile device 100 may include one of a call signal reception, a message reception, a key signal input, a touch input and/or the like. The alarm 153 may output a signal for announcing an event occurrence by way of vibration or the like as well as a video signal or an audio signal. The video signal may be outputted via the display 151. The audio signal may be outputted via the audio output module 152. The display 151 or the audio output module 152 may be classified as part of the alarm 153.

The haptic module 154 may bring about various haptic effects that can be sensed by a user. Vibration is a representative example for the haptic effect brought about by the haptic module 154. Strength and pattern of the vibration generated from the haptic module 154 may be controllable. For example, vibrations differing from each other may be outputted in a manner of being synthesized together or may be sequentially outputted.

The haptic module 154 may generate various haptic effects including a vibration, an effect caused by such a stimulus as a pin array vertically moving against a contact skin surface, a jet power of air via outlet, a suction power of air via inlet, a skim on a skin surface, a contact of an electrode, an electrostatic power and the like, and/or an effect by hot/cold sense reproduction using an endothermic or exothermic device as well as the vibration.

The haptic module 154 may provide the haptic effect via direct contact. The haptic module 154 may enable a user to experience the haptic effect via muscular sense of a finger, an arm and/or the like. Two or more haptic modules 154 may be provided according to a configuration of the mobile device 100.

The memory 160 may store a program for operations of the controller 180. The memory 160 may temporarily store input/output data (e.g., phonebook, message, still screen, moving screen, etc.). The memory 160 may store data of vibration and sound in various patterns outputted in case of a touch input to the touchscreen.

The memory 160 may include at least one of a flash memory, a hard disk, a multimedia card micro type memory, a card type memory (e.g., SD memory, XD memory, etc.), a random access memory (RAM), a static random access memory (SRAM), a read-only memory (ROM), an electrically erasable programmable read-only memory, a programmable read-only memory, a magnetic memory, a magnetic disk, an optical disk, and/or the like. The mobile device 100 may operate in association with a web storage that performs a storage function of the memory 160 in the Internet.

The interface unit 170 may play a role as a passage to external devices connected to the mobile device 100. The interface unit 170 may receive data from an external device. The interface unit 170 may be supplied with a power and then the power may be delivered to elements within the mobile device 100. The interface unit 170 may enable data to be transferred to an external device from an inside of the mobile device 100. The interface unit 170 may include a wire/wireless headset port, an external charger port, a wire/wireless data port, a memory card port, a port for coupling to a device having an identity module, an audio input/output (I/O) port, a video input/output (I/O) port, an earphone port and/or the like.

The identity module may be a chip or card that stores various kinds of information for authenticating use of the mobile device 100. The identify module may include a user identity module (UIM), a subscriber identity module (SIM), a universal subscriber identity module (USIM) and/or the like. A device provided with the above identity module (hereafter an identity device) may be manufactured in the form of a smart card. The identity device may be connected to the mobile device 100 via the port.

The interface unit 170 may play a role as a passage for supplying a power to the mobile device 100 from a cradle that is connected to the mobile device 100. The interface unit 170 may play a role as a passage for delivering various command signals, which are inputted from the cradle by a user, to the mobile device 100. Various command signals inputted from the cradle or the power may work as a signal for recognizing that the mobile device 100 is correctly loaded in the cradle.

The controller 180 may control overall operations of the mobile device 100. For example, the controller 180 may perform control and processing relevant to a voice call, a data communication, a video conference and/or the like. The controller 180 may have a multimedia module 181 for multimedia playback. The multimedia module 181 may be implemented within the controller 180 or may be configured separate from the controller 180.

The controller 180 may perform pattern recognizing processing for recognizing a handwriting input performed on the touchscreen as a character an/or recognizing a screen drawing input performed on the touchscreen as an image.

The power supply 190 may receive an external or internal power and then supply the power required for operations of the respective elements under control of the controller 180.

Embodiments of the present invention explained in the following description may be implemented within a recording medium that can be read by a computer or a computer-like device using software, hardware or combination thereof.

According to the hardware implementation, arrangements and embodiments may be implemented using at least one of application specific integrated circuits (ASICs), digital signal processors (DSPs), digital signal processing devices DSPDs), programmable logic devices (PLDs), field programmable gate arrays (FPGAs), processors, controllers, microcontrollers, microprocessors and electrical units for performing other functions. In some cases, embodiments may be implemented by the controller 180.

For a software implementation, arrangements and embodiments described herein may be implemented with separate software modules, such as procedures and functions, each of which may perform one or more of the functions and operations described herein. Software codes may be implemented with a software application written in any suitable programming language and may be stored in memory such as the memory 160, and may be executed by a controller or processor, such as the controller 180.

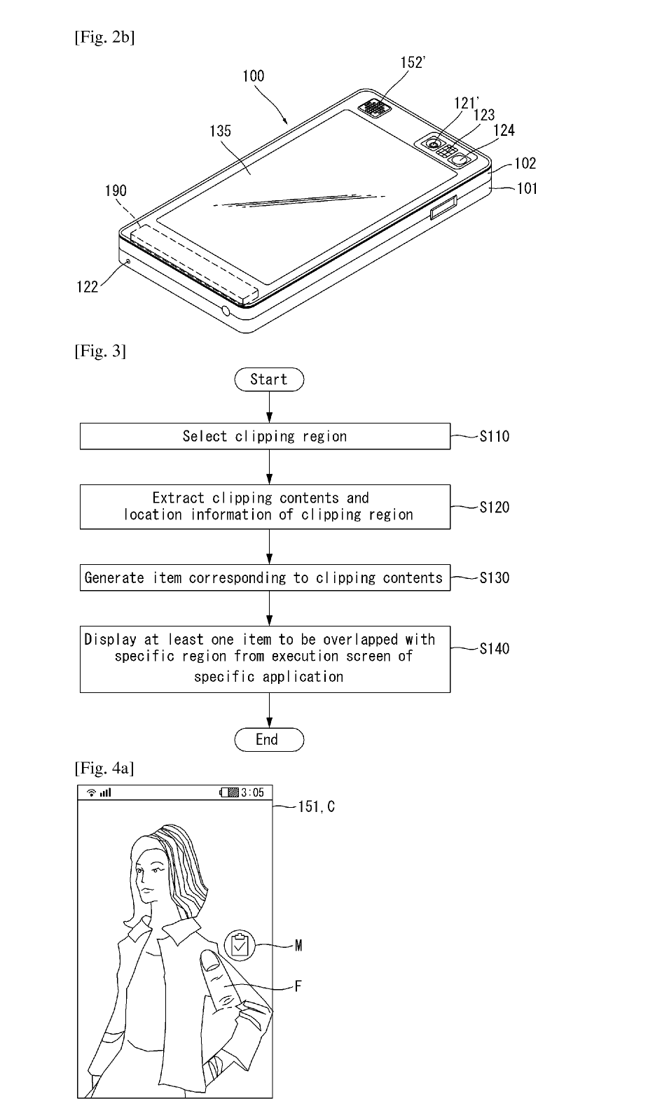

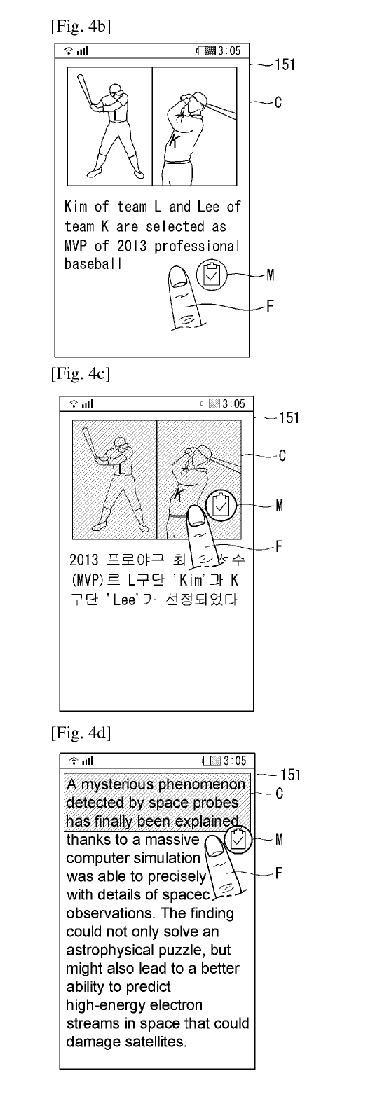

FIG. 2A is a front-view of a mobile device according to an example embodiment. Other embodiments, configurations and arrangements may also be provided.

As shown in FIG. 2A, the mobile device 100 may include a bar type device body. Embodiments of the mobile device may be implemented in a variety of different configurations. Examples of such configurations may include a folder-type, a slide-type, a bar-type, a rotational-type, a swing-type and/or combinations thereof.

The body may include a case (casing, housing, cover, etc.) that forms an exterior of the device. The case may be divided into a front case 101 and a rear case 102. Various electric/electronic parts may be provided in a space between the front case 101 and the rear case 102. A middle case may be further provided between the front case 101 and the rear case 102.

The cases may be formed by injection molding of synthetic resin or may be formed of metal substance such as stainless steel (STS), titanium (Ti) or the like, for example.

The display 151, the audio output unit 152, the camera 121, user input units 130/131/132, the microphone 122, the interface unit 170 and the like may be provided on the device body, and more particularly on the front case 101.

The display 151 may occupy most of a main face of the front case 101. The audio output module 152 and the camera 121 may be provided at an area adjacent to one end portion of the display 151, while the user input unit 131 and the microphone 122 may be provided at another area adjacent to the other end portion of the display 151. The user input unit 132 and the interface unit 170 may be provided on lateral sides of the front and rear cases 101 and 102.

The user input unit 130 may receive a command for controlling an operation of the mobile device 100. The user input unit 130 may include a plurality of manipulating units 131 and 132. The manipulating units 131 and 132 may be called a manipulating portion and may adopt any mechanism of a tactile manner that enables a user to perform a manipulation action by experiencing a tactile feeling.

Content inputted by the first manipulating unit 131 or the second manipulating unit 132 may be diversely set. For example, a command such as start, end, scroll and/or the like may be inputted to the first manipulating unit 131. A command for a volume adjustment of sound outputted from the audio output unit 152, a command for a switching to a touch recognizing mode of the display 151 or the like may be inputted to the second manipulating unit 132.

FIG. 2B is a perspective diagram of a backside of the mobile device shown in FIG. 2A. Other embodiments, configurations and arrangements may also be provided.

As shown in FIG. 2B, a camera 121′ may be additionally provided on a backside of the device body, and more particularly on the rear case 102. The camera 121′ may have a photographing direction that is substantially opposite to a photographing direction of the camera 121 (shown in FIG. 2A) and may have pixels differing from pixels of the camera 121.

For example, the camera 121 may have a lower number of pixels to capture and transmit a screen of user's face for a video call, while the camera 121′ may have a greater number of pixels for capturing a general subject for photography without transmitting the captured subject. Each of the cameras 121 and 121′ may be installed on the device body to be rotated and/or popped up.

A flash 123 and a mirror 124 may be additionally provided adjacent to the camera 121′. The flash 123 may project light toward a subject in case of photographing the subject using the camera 121′. If a user attempts to take a screen of the user (self-photography) using the camera 121′, the mirror 124 may enable the user to view a user's face reflected by the mirror 124.

An additional audio output unit 152′ may be provided on the backside of the device body. The additional audio output unit 152′ may implement a stereo function together with the audio output unit 152 shown in FIG. 2A and may be used for implementation of a speakerphone mode in talking over the device.

A broadcast signal receiving antenna 124 may be additionally provided at the lateral side of the device body as well as an antenna for communication or the like. The antenna 124 may be considered a portion of the broadcast receiving module 111 shown in FIG. 1 and may be retractably provided on the device body.

The power supply 190 for supplying a power to the mobile device 100 may be provided to the device body. The power supply 190 may be built within the device body. Alternatively, the power supply 190 may be detachably connected to the device body.

FIG. 2B also shows a touchpad 135 for detecting a touch that is additionally provided on the rear case 102. The touchpad 135 may be configured in a light transmittive type like the display 151. If the display 151 outputs visual information from both faces, the display 151 may recognize visual information via the touchpad 135 as well. The information outputted from both of the faces may be controlled by the touchpad 135. Alternatively, a display may be further provided to the touchpad 135 so that a touchscreen may also be provided to the rear case 102.

The touchpad 135 may be activated by interconnecting with the display 151 of the front case 101. The touchpad 135 may be provided in rear of the display 151 in parallel to one another. The touchpad 135 may have a size equal to or less than a size of the display 151.

Hereinafter embodiments will be described.

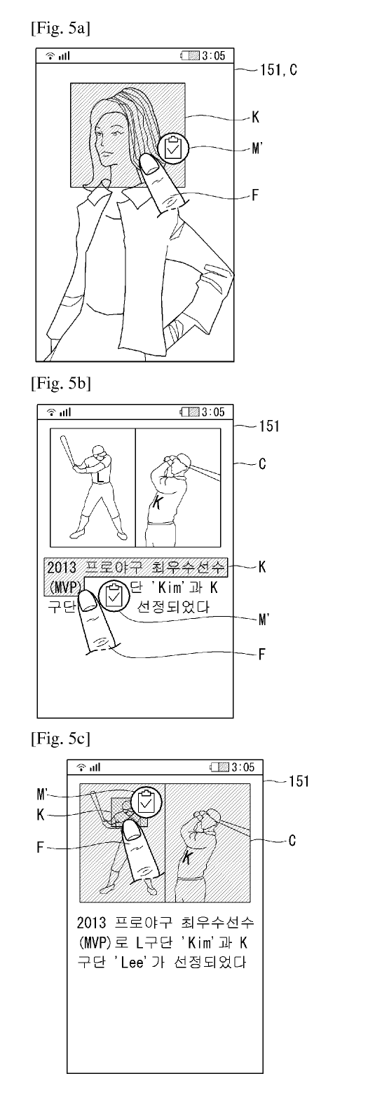

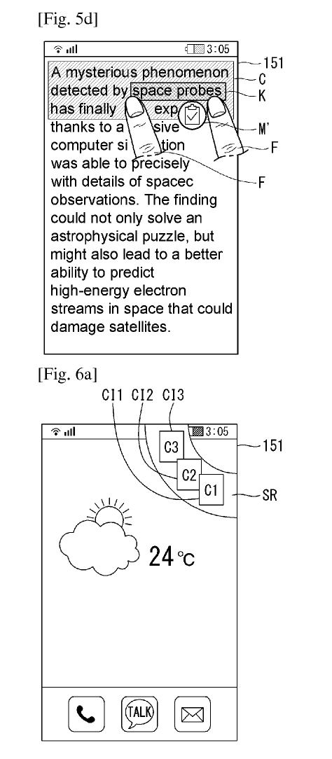

FIG. 3 is a flowchart illustrating a method for controlling an electronic device according to a first embodiment, and FIGS. 4A to 8D are diagrams illustrating a method for controlling an electronic device according to a first embodiment.

Referring to FIG. 3, a controller 180 of FIG. 1 may select a region on which desired contents are displayed from an execution screen of a specific application as a clipping region (S110).

In detail, the controller 180 may select a region displayed on the display 150 from the execution screen of the specific application as the clipping region, and may designate and select a part of the region displayed on the display 150 as the clipping region. Further, the controller 180 may select a plurality of clipping regions from the same execution screen of a specific application.

Next, when receiving an input to select at least one clipping region from the execution screen of the specific application, the controller 180 may execute an application (hereinafter referred to as ‘Quick Clip’) to integrally manage at least one clipping contents. The controller 180 of FIG. 1 may execute the specific application as a fore-ground, and may execute the Quick Clip application as a back-ground. The controller 180 of FIG. 1 may extract at least one clipping contents included in at least one clipping region selected through the executed Quick Clip application and location information of the clipping region (S120). The controller 180 of FIG. 1 may integrate the at least one clipping contents extracted from the at least one clipping region selected from the execution screen of the specific application with at least one clipping contents previously extracted through the Quick Clip application to manage the integration clipping contents.

The controller 180 of FIG. 1 may generate an item corresponding to the clipping contents (S130). In this case, the controller 180 of FIG. 1 may generate the clipping contents and the item in one-to-one correspondence or generate the item as representation of a plurality of clipping contents.

The controller 180 of FIG. 1 may include at least one of clipping contents, thumbnail information, key contents, and an icon of an application extracting the clipping contents as the item. When the item is the clipping contents and key contents are selected from the clipping contents, the controller 180 of FIG. 1 may display the key contents of the item to be discriminated from contents having other characteristics by bold processing, highlighting, and brightness processing.

The controller 180 of FIG. 1 may display at least one item to be overlapped with a specific region from the execution screen of the specific application (S140). The specific region signifies a region on which the execution screen of the Quick Clip application is displayed, and one of corner regions having a fan shape may be designated as the specific region. Further, the controller 180 of FIG. 1 may designate the specific region as a circular bar-type region having a preset width among regions having the fan shape formed based on a corner of the display. Hereinafter a specific region of a display on which the execution screen of the Quick Clip application is displayed is referred to as ‘Quick Clip Bar’.

The controller 180 of FIG. 1 may set a position of the Quick Clip Bar to be automatically changed to one of four corners according to a touch track input through the display 151. For example, a farthest corner region located away from the latest received touch input may be designated as Quick Clip Bar.

If the clipping region is selected, the controller 180 of FIG. 1 automatically changes an execution screen of the Quick Clip application to a fore-ground to display an item corresponding to the clipping contents on the Quick Clip Bar.

Meanwhile, although the clipping region is selected, when the Quick Clip application is executed as the back-ground and a specific input with respect to a region corresponding to the Quick Clip Bar is received, the controller 180 of FIG. 1 may change the execution screen of the Quick Clip application to the fore-ground and may display at least one item on the Quick Clip Bar. In detail, when a first input with respect to the Quick Clip Bar is received, the controller 180 of FIG. 1 may display at least one item corresponding to the clipping contents on a specific region. When a second input is received, the controller 180 may release display at least one item corresponding to at least one clipping contents. In this case, the specific input, a first input or a second input may be one of a drag input of a circumferential direction from a center of a corner region of the display or a drag input in a central direction from a circumferential surface.

When the execution screen of the Quick Clip application is changed to the fore-ground, the controller 180 of FIG. 1 may display an edge of a Quick Clip Bar together with one item. Further, the controller 180 of FIG. 1 may opaquely display the Quick Clip Bar, and may display at least one item on the opaque Quick Clip Bar.

Although the foregoing embodiment has illustrated that the Quick Clip application is executed during execution of the fore-ground of the specific application, when only the Quick Clip application is executed as the fore-ground, the Quick Clip Bar may be displayed to be overlapped with a partial region of a home screen.

When the at least one item cannot be displayed on the Quick Clip Bar, the controller 180 of FIG. 1, the controller 180 of FIG. 1 may hide an item displayed on a current Quick Clip Bar through a specific input with respect to the Quick Clip Bar and may display an item which is not displayed on the Quick Clip Bar. In this case, the specific input may be a drag input with respect to two-ways (left direction or right direction) in which at least on icon is displayed on the Quick Clip Bar.

When a specific input with respect to a specific item among items displayed on the Quick Clip Bar is received, the controller 180 of FIG. 1 may enlarge and display specific clipping contents on a pop-up window or may perform a shortcut to an execution screen of a specific application corresponding to location information of a specific clipping region including specific clipping contents. When the shortcut is performed to the execution screen of the specific application corresponding to location information of the specific clipping region, the controller 180 of FIG. 1, the controller 180 of FIG. 1 may display display characteristics of the clipping region to be distinguished from those of other regions or may display an indicator on a specific clipping region. When one touch input with respect to a specific item is received, the controller 180 of FIG. 1 displays the pop-up window. When a continuous touch input or a long touch input is received, the controller 180 may set to perform the shortcut. The one touch input is used to discriminate the long touch input, and may be defined as one touch less than a threshold time based on a threshold time.

When a specific item is an icon of an application selecting at least one clipping contents and a specific input with respect to the specific item is received, the controller 180 of FIG. 1 may display the latest selected clipping contents as a pop-up window. When receiving an input requesting zoom out or pinch out with respect to a pop-up window on which the specific clipping contents are displayed, the controller 180 of FIG. 1 may display a plurality of clipping contents on the pop-up window.

When receiving an input requesting zoom out or pinch out with respect to a pop-up window on which a plurality of clipping contents are displayed, the controller 180 of FIG. 1 may display only the specific clipping contents on the pop-up window.

The controller 180 of FIG. 1 may display other clipping contents on a pop-up window through a upward, downward, left, or right drag input or a flicking input with respect to the pup-up window. The controller 180 of FIG. 1 may set a left or right drag input (or flicking input) with respect to the pop-up window as a control signal displaying clipping contents selected from the same execution screen, and may set the upward or downward drag input (or flicking input) as a control signal displaying clipping contents selected from other execution screen of the same application.

When receiving an input selecting a pop-up window to enlarge and display specific clipping contents, the controller 180 of FIG. 1 may execute a shortcut to a specific clipping region including the specific clipping contents.

The controller 180 of FIG. 1 may determine a method of executing the shortcut to the specific clipping region whether the specific application from which the specific clipping contents are extracted is preloaded.

In detail, when the specific application is preloaded, the controller 180 of FIG. 1 may execute a shortcut to a clipping region by storing an URL address and a scroll movement history corresponding to a clipping region in a case of a web browser according to a type of a specific application. The controller 180 of FIG. 1 may execute a shortcut to a clipping region by storing a dialogue threshold and scroll movement input in a case of an SMS. The controller 180 of FIG. 1 may execute a shortcut to a clipping region by storing corresponding file information and line information in a case of a text editor. That is, the controller 180 of FIG. 1 may store specific application information, threshold information, file information, tag information, a scroll coordinate, and line information extracting clipping contents, and may extract location information of a clipping region using the stored information.

When the specific application is preloaded, the controller 180 of FIG. 1 may perform the shortcut to the clipping region using cache information.

Accordingly, if the clipping region is selected, the controller 180 of FIG. 1 may execute the shortcut to the clipping region when a specific application does not preload the location information of the clipping region by generating (extracting) and storing location information when the specific application is not preloaded or the specific application is preloaded.

When specific inputs with respect to other items are sequentially received, the controller 180 of FIG. 1 may display a plurality of pop-up windows. When a specific input with respect to an item is again received, the controller 180 of FIG. 1 may set to release display of the pop-up window. If a preset time elapses, the controller 180 of FIG. 1 may set to automatically release display of the pop-up window, or may set to release the display of the pop-up window by a combination thereof. When an application other than an application in which the clipping contents are selected uses the clipping contents (for example, case of inspiring clipping contents into an input item), the controller 180 of FIG. 1 may display a used history on an item corresponding to the clipping contents as an indicator. In detail, the controller 180 of FIG. 1 may display an icon of an application using the specific clipping contents as an item corresponding to specific clipping contents.

Referring to FIGS. 4A to 18D, the method of controlling the electronic device according to the first embodiment will be described in detail.

FIGS. 4A to 4D are diagrams illustrating a method for selecting a clipping region in an electronic device according to a first embodiment.

Referring to FIGS. 4A and 4B, when a specific input with respect to a predetermined point of the display 151 on which an image or a web page is displayed is received, the controller 180 of FIG. 1 may display a clipping icon M indicating a clipping region selection menu. In this case, the specific input may include one touch, a long touch, and a continuous touch input.

When an input with respect to the clipping icon M is received, the controller 180 of FIG. 1 may provide a guide line capable of selecting a described region to be clipped from a screen displayed on the display 151. When the desired region is not selected, the controller 180 of FIG. 1 may select the screen currently displayed on the display 151 as the clipping region C.

Referring to FIGS. 4C and 4D, when receiving a specific input with respect to a predetermined point of the display 151 on which a memo note or a web page is displayed, the controller 180 of FIG. 1 may display the clipping icon M indicating a clipping region selection menu. In this case, the specific input may include one touch, a long touch, and a continuous touch input.

When receiving an input with respect to the clipping icon M, the controller 180 of FIG. 1 may provide a guide line capable of selecting a described region to be clipped from the screen displayed on the display 151. The controller 180 of FIG. 1 may select a region on which a specific text or a specific image is displayed as the desired region and may select the selected desired region as the clipping region C.

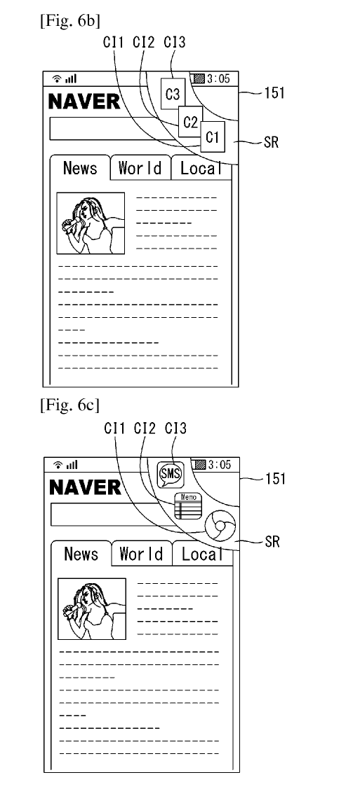

FIGS. 5A to 5D are diagrams illustrating a method for selecting main contents from the clipping region in an electronic device according to a first embodiment. Referring to FIGS. 5A to 5D, the controller 180 of FIG. 1 may further select main contents K from the selected clipping region C.

In detail, when a specific input with respect to a predetermined point of the clipping region C is received after the clipping region C is selected in the method of FIGS. 4A to 4D, the controller 180 of FIG. 1 may display a clipping icon M′ indicating a menu capable of selecting the main contents K.

When receiving the input with respect to the clipping icon M′, the controller 180 of FIG. 1 may provide a guide line capable of selecting the main contents K. The controller 180 of FIG. 1 may select a specific text or a specific image as the main contents.

The controller 180 of FIG. 1 may select an image of a face region from the clipping contents C as the main contents K (see FIGS. 5A and 5c), and may select the specific text as the main contents K (see FIGS. 5B and 5D).

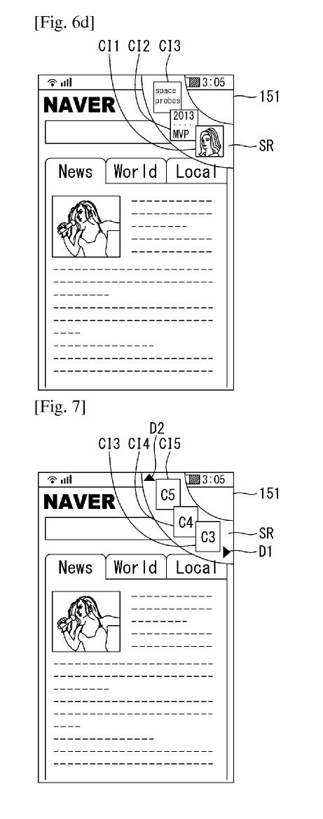

FIGS. 6A to 6D are diagrams illustrating a method for displaying an item corresponding to clipping contents in an electronic device according to a first embodiment. Referring to FIGS. 6A to 6D, the controller 180 of FIG. 1 may display at least one item CI1, CI2, and CI3 displayed on a Quick Clip Bar (SR). Further, the controller 180 of FIG. 1 may display the at least one item CI1, CI2, and CI3 displayed on a Quick Clip Bar (SR) as one of clipping contents, an application selecting the clipping region or main contents.

Referring to FIG. 6A, the controller 180 of FIG. 1 may designate one of corner regions of the display 151 on which a home screen is displayed as the Quick Clip Bar (SR), and may display three items CI1, CI2, and CI3 on the Quick Clip Bar (SR).

Referring to FIG. 6B, the controller 180 of FIG. 1 may designate one of corner regions of the display 151 on which an execution screen is displayed as the Quick Clip Bar (SR), and may display three items CI1, CI2, and CI3 on the Quick Clip Bar (SR).

Referring to FIGS. 6A and 6B, the controller 180 of FIG. 1 may display the at least one items CI1, CI2, and CI3 on the Quick Clip Bar (SR) as the clipping contents C1, C2, and C3.

Referring to FIG. 6C, the controller 180 of FIG. 1 may display the at least one item CI1, CI2, CI3 on the Quick Clip Bar (SR) as an icon of the application selecting the clipping region.

Referring to FIG. 6D, the controller 180 of FIG. 1 may display the at least one item CI1, CI2, and CI3 on the Quick Clip Bar SR as the main contents.

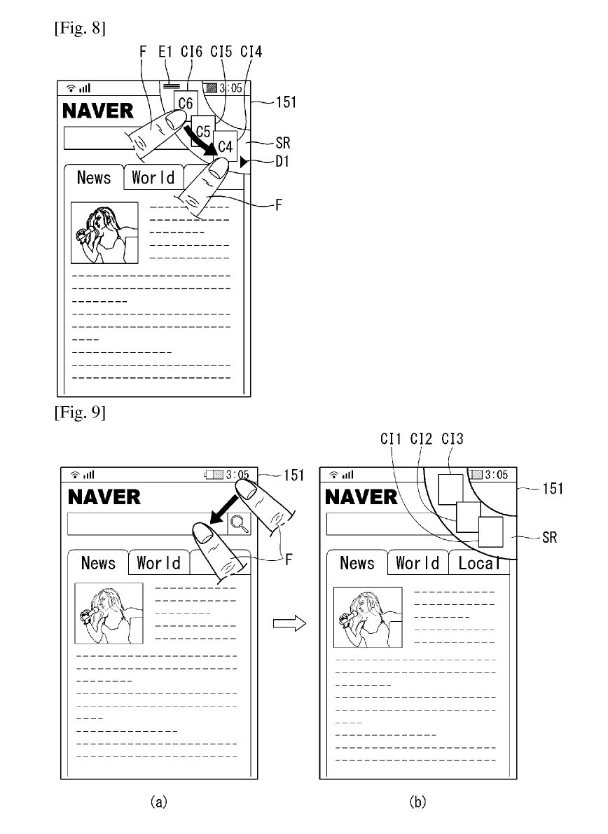

FIGS. 7 and 8 are diagrams illustrating a method for displaying a plurality of clipping contents in an electronic device according to a first embodiment. The controller 180 of FIG. 1 may display an item corresponding to the clipping contents on the Quick Clip Bar SR according to a clipping order or a preset arrangement order. The controller 180 of FIG. 1 may represent presence of an item which is not displayed on a limited Quick Clip Bar SR using an indicator.

Referring to FIG. 7, the controller 180 of FIG. 1 may further display indicators D1 and D2 at a side of an item which is not displayed on the Quick Clip Bar SR. Further, the controller 180 of FIG. 1 may display brightness of a region on which indicators D1 and D2 are displayed to be distinguished from that of other regions.

Referring to FIG. 8, the controller 180 of FIG. 1 may display the indicator D1 of a side of an item which is not displayed on the Quick Clip Bar SR and an indicator E1 of a side in which the non-displayed item is absent.

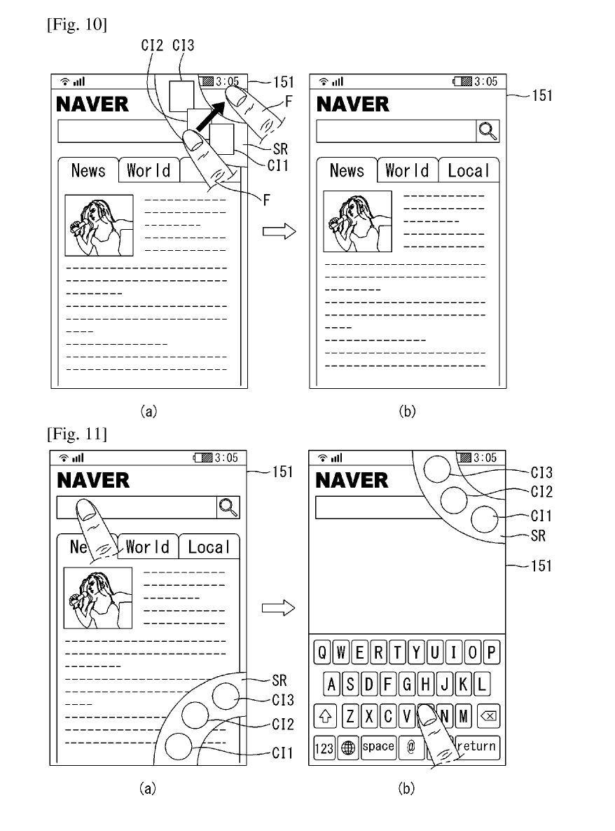

FIGS. 9 and 10 are diagrams illustrating a method for switching an execution screen of an application to manage clipping contents to a back-ground or a fore-ground in an electronic device according to a first embodiment.

Referring to FIG. 9, when receiving a first input with respect to a corner region corresponding to the Quick Clip Bar SR, the controller 180 of FIG. 1 may switch an execution screen of a Quick Clip application to a fore-ground, and may display at least one item CI1, CI2, and CI3 on the Quick Clip Bar SR, and may display at least one CI1, CI2, and CI3 on the Quick Clip Bar SR.

Referring to FIG. 10, when receiving a second input with respect to the Quick Clip Bar SR in a state that at least one CI1, CI2, and CI3 are displayed on the Quick Clip Bar SR, the controller 180 of FIG. 1 may switch the execution screen of the Quick Clip application to a back-ground, and may release display of the at least one item CI1, CI2, and CI3 on the Quick Clip Bar SR. In this case, when an edge of the Quick Clip Bar SR is displayed or opaquely displayed, the controller 180 of FIG. 1 may release the display of the edge and opaque display.

The first input and the second input may include a drag input of a flicking input to cross the Quick Clip Bar SR and which is located in an opposite direction.

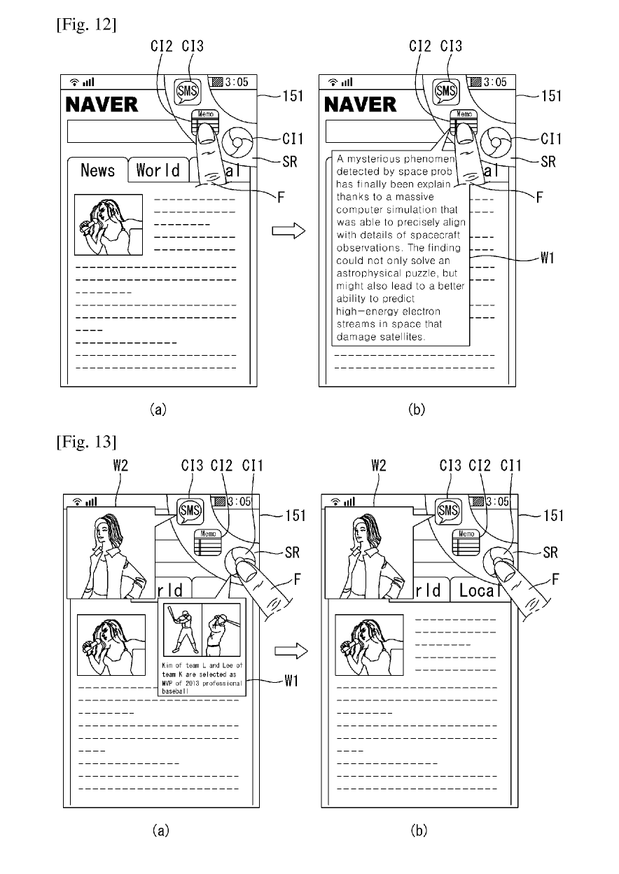

FIG. 11 is a diagram illustrating a method for designating a specific region in an electronic device according to a first embodiment.

Referring to FIG. 11, the controller 180 of FIG. 1 may designate the farthest corner region as the Quick Clip Bar SR according to a touch track received by the display 151.

In detail, a touch input is received at a upper left end of a screen of the display 151, the controller 180 of FIG. 1 may designate the Quick Clip Bar SR as a lower right corner region (see FIG. 11A).

Next, when a touch input is received at a lower left end of a screen of the display 151, the controller 180 of FIG. 1 may automatically change a position of the Quick Clip Bar SR according to a touch track so that the Quick Clip Bar SR is designated as the upper right corner region.

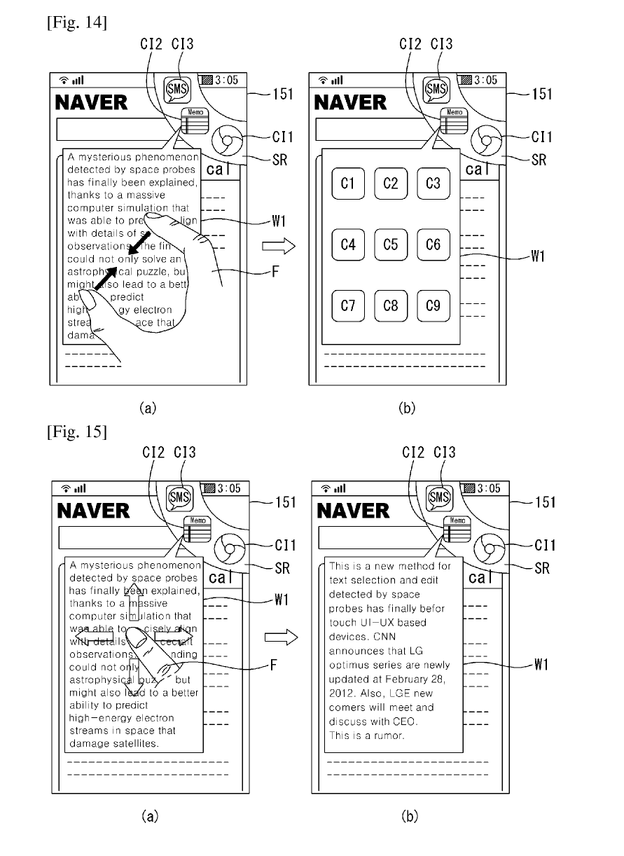

FIGS. 12 to 15 are diagrams illustrating a method for previously confirming clipping contents in an electronic device according to a first embodiment.

Referring to FIG. 12, when an input with respect to a specific item CI2 from items CI1, CI2, and CI3 displayed on the Quick Clip Bar SR, the controller 180 of FIG. 1 may enlarge and display clipping contents associated with a specific item CI2 as a pop-up window W1.

For example, when the specific item CI2 is an icon of a specific application, the controller 180 of FIG. 1 may display the latest clipping contents extracted from the clipping contents selected from a specific application.

When clipping contents associated with a first specific item CI1 among the items CI1, CI2, and CI3 are enlarged and displayed as a first pop-up window W1 and an input with respect to the second specific item CI3 is received, the controller 180 of FIG. 1 may enlarge and display the clipping contents associated with the second specific item CI3 as a second pop-up window W2. That is, when sequentially receiving inputs with respect to a plurality of items CI1, CI2, and CI3 displayed on the Quick Clip Bar SR, the controller 180 of FIG. 1 may display associated clipping contents as a pop-up window according to an input order.

Referring to FIG. 13, when receiving an input with respect to a specific item, the controller 180 of FIG. 1 may release display of a pop-up window associated with the specific item.

For example, when again receiving the input with respect to the first specific item in a state that the first pop-up window W1 is displayed (see FIG. 13A), the controller 180 of FIG. 1 may release display of the first pop-up window W1 (see FIG. 13B).

When a preset time elapses or an input with respect to another specific item is received, the controller 180 of FIG. 1 may set to release display of the pop-up window.

Referring to FIG. 14, when receiving a zoom out or pinch out input with respect to the pop-up window W1 in which specific clipping contents associated with the specific item C12 is enlarged and displayed, the controller 180 of FIG. 1 may display a plurality of reduced clipping contents C1 to C9 associated with the specific item CI2 together with the pop-up window W1.

Although not shown, when receiving a zoom in or pinch in input with respect to the pop-up window W1, the controller 180 of FIG. 1 may restore display of the pop-up window W1 to a previous state.

When receiving a upward, downward, left, or right drag input or a flicking input with respect to the pup-up window on which specific clipping contents associated with a specific item CI2 are enlarged and displayed, the controller 180 of FIG. 1 may display other clipping contents selected from a specific application.

For example, the controller 180 of FIG. 1 may set left and right drag inputs as a control signal to move clipping contents selected from the same execution screen of a specific application, and may set upward and downward drag inputs as a control signal to move clipping contents selected from another execution screen of a specific application.

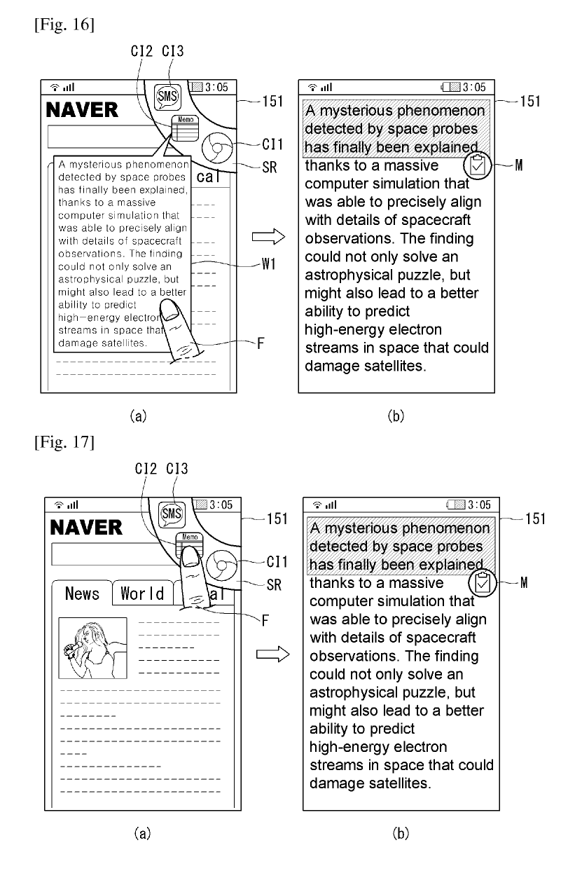

FIGS. 16 and 17 are diagrams illustrating a method for executing a shortcut to a clipping region corresponding to clipping contents in an electronic device according to a first embodiment.

Referring to FIG. 16, when receiving a selection input with respect to a pop-up window W1 on which specific clipping contents associated with a specific item CI2 are enlarged and displayed, the controller 180 of FIG. 1 may execute a shortcut to a clipping region including specific clipping contents.

Accordingly, the controller 180 of FIG. 1 may display an execution screen of a specific application in which a specific region is selected on the display 151, and display a display characteristic of a specific region of the execution screen to be distinguished from that of other regions or display an indicator M indicating the specific region.

Referring to FIG. 17, when receiving a specific input (for example, a long touch or a continuous touch input) with respect to the specific item CI2, the controller 180 of FIG. 1 may execute the shortcut to a clipping region including clipping contents associated with a specific item CI2.

When the specific item CI2 is an icon of the specific application, the controller 180 of FIG. 1 may execute the shortcut to the clipping region including the latest extracted clipping contents from the specific application.

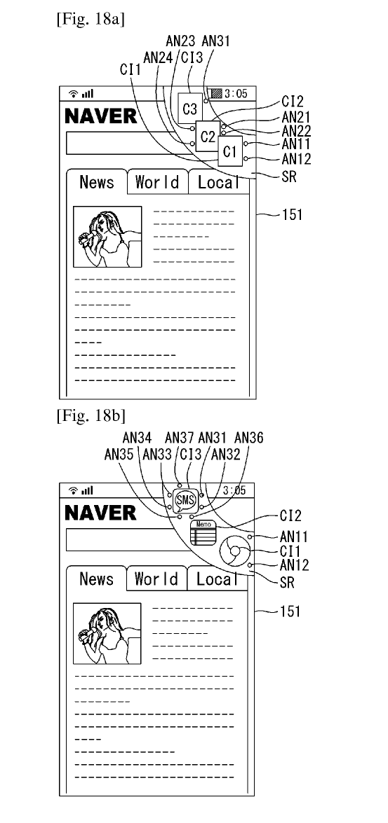

FIGS. 18A to 18D are diagrams illustrating a method for displaying a used history of clipping contents in an electronic device according to a first embodiment.

Referring to FIGS. 18A and 18B, the controller 180 of FIG. 1 may display indicators AN11, AN12, AN21-AN24, AN31 with respect to items CI1, CI2, and CI3 where a used history of the clipping contents are displayed on the Quick Clip Bar SR.

In detail, when the items displayed on the Quick Clip Bar SR indicate clipping contents (see FIG. 18A), the controller 180 of FIG. 1 may directly display indicators AN11, AN12, AN21-AN24, AN31 with respect to the items CI1, CI2, and CI3 corresponding to clipping contents.

When the items displayed on the Quick Clip Bar SR indicate an icon of an application (see FIG. 18B), the controller 180 of FIG. 1 may display indicators AN11, AN12, AN21-AN24, AN31 with respect to the items CI1, CI2, and CI3 of an application from which the clipping contents are extracted.

Referring to FIG. 18C, the controller 180 of FIG. 1 may display a used history of clipping contents as indicators AN11, AN12, AN21-AN24, AN31 with respect to reduced clipping contents associated with the specific item CI1.

Referring to FIG. 18d, the controller 180 of FIG. 1 may doubly display the used history of the clipping contents as indicators AN11, AN12, AN21-AN24, AN31 with respect to reduced clipping contents associated with items CI1, CI2, and CI3 and the specific item CI1 displayed on the Quick Clip Bar SR.

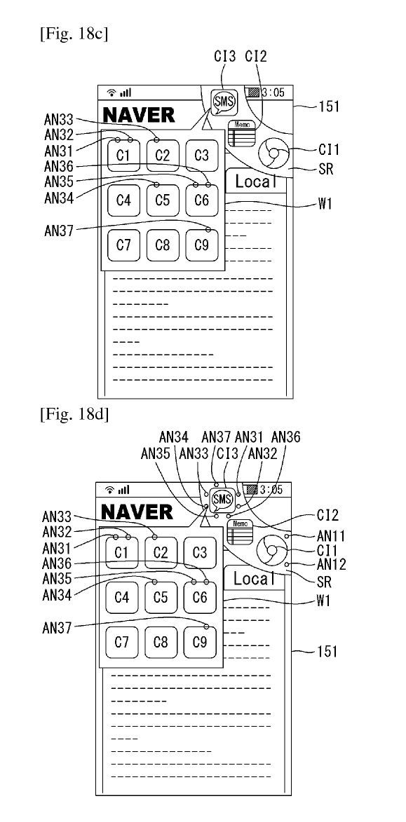

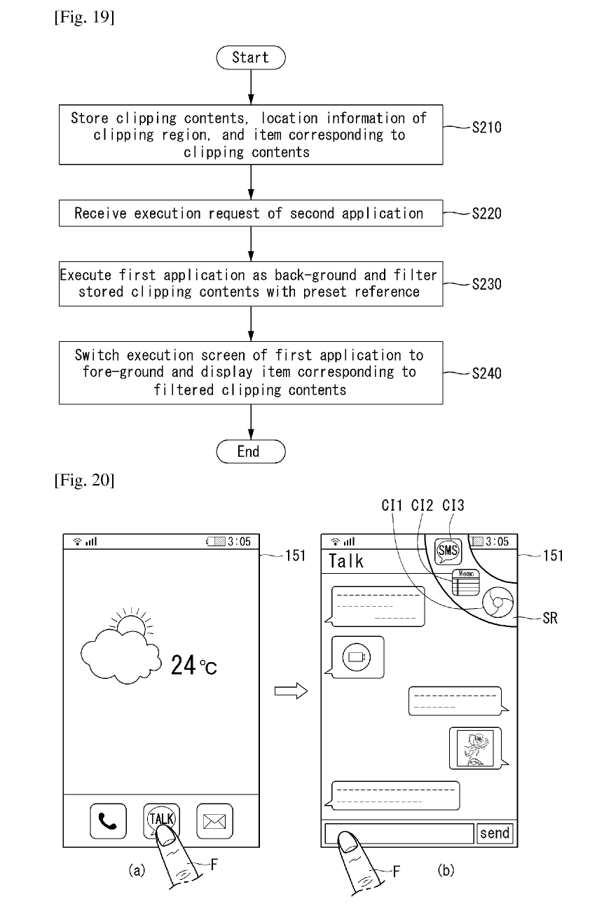

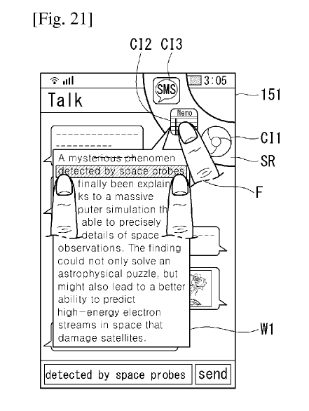

FIG. 19 is a diagram illustrating a method for controlling an electronic device according to a second embodiment, and FIGS. 20 and 21 are diagrams illustrating a method for controlling an electronic device according to a second embodiment.

Referring to FIG. 19, the controller 180 of the electronic device shown FIG. 1 may store at least one clipping contents included in at least one clipping region selected from an execution screen of at least one application through a Quick Clip application, location information of at least one clipping region, and at least one item corresponding to the at least one clipping contents (S210).

Next, the controller 180 of FIG. 1 may receive an execution request of a specific application (S220). In this case, the specific application signifies an application except for a Quick Clip application.

The controller 180 of FIG. 1 may execute a Quick Clip application as a back-ground to filter at least one clipping contents stored according to a type of a specific application with a preset reference (S230). Since the Quick Clip application is executed as the back-ground, the controller 180 of FIG. 1 does not display the Quick Clip Bar.

When an input item is included in the execution screen of a specific application, the controller 180 of FIG. 1 switches an execution screen of the Quick Clip application to a fore-ground, and displays an item corresponding to the filtered clipping contents (S240).

According to the second embodiment, the controller 180 of FIG. 1 may determine whether to display a Quick Clip Bar according to a type of the specific application and a configuration of an execution screen, and may filter and provide clipping contents having high use possibility associated with the specific application among clipping contents.

FIG. 20 is a diagram illustrating a method for displaying clipping contents filtered by the electronic device according to a second embodiment.

When receiving an execution request of an application providing an instant messaging service, the controller 180 of FIG. 1 may execute an application providing the instant messaging service to display an execution screen, and may execute a Quick Clip application as a fore-ground to filter clipping contents by taking a type of an application providing the instant messaging service into consideration.

In detail, the application providing the instant messaging service is a service to transmit texts, images, and moving images to other devices and the controller 180 of FIG. 1 may filter clipping contents stored as the texts, the images, or videos through a Quick Clip application. Further, the controller 180 of FIG. 1 may filter and provide clipping contents according to a type of data to be mainly transmitted through an application providing an executed instant messaging service. In addition, the controller 180 of FIG. 1 may set a use application based on filtering of the clipping contents with reference to a use application specification before or after an application providing an executed instant messaging service.

For example, when executing an SMS application CI3, a memo note application CI2, and a search application CI1 to copy contents, and a used history transmitting copied contents using an application providing an instant messaging service, the controller 180 of FIG. 1 may set clipping contents selected from the SMS application CI3, the memo note application CI2, and the search application CI1 as a filtering reference.

Accordingly, when an execution screen including an input item of the instant messaging service is displayed, the controller 180 of FIG. 1 may display the filtered clipping contents on a Quick Clip Bar SR.

When receiving a specific input after the filtered clipping contents are displayed on the Quick Clip Bar SR, the controller 180 of FIG. 1 may convert the filtered clipping contents displayed on the Quick Clip Bar SR into total clipping contents to display the converted total clipping contents.

In this case, the specific input may include a drag input (or flicking input) in a specific direction with respect to the Quick Clip Bar SR, a continuous touch input, and a geometrical touch input in clockwise or counterclockwise.

FIG. 21 is a diagram illustrating a method for adding at least some of clipping contents filtered by the electronic device according to a second embodiment.

When displaying an execution screen including an input item of an application providing an instant messaging service, the controller 180 of FIG. 1 may display the filtered clipping contents on the Quick Clip Bar SR.

When receiving an input with respect to the specific item CI2 corresponding to clipping contents displayed on the Quick Clip Bar SR, the controller 180 of FIG. 1 may display may enlarge and display corresponding clipping contents as a pop-up window W1. In this case, when the specific item CI2 is contents, the corresponding clipping contents are corresponding contents. When the specific item CI2 is an icon indicating an associated application, the corresponding clipping contents may represent the latest extracted clipping contents from the associated application.

The controller 180 of FIG. 1 may select and copy some from specific clipping contents displayed on the pop-up window W1 and inspire the some clipping contents in an input item of an application providing an instant messaging service to use the input item. When receiving a drag input with respect to a region corresponding to some contents, the controller 180 of FIG. 1 may process a selection input with respect to some contents.

In addition, when editing an input item of an application providing the instant messaging service, the controller 180 of FIG. 1 may directly inspire contents selected when receiving an input selecting at least some contents from clipping contents displayed on the pop-up window W1 in the input item. That is, the controller 180 of FIG. 1 may set a control signal to perform an inspiration function after copying the selection input with respect to the clipping contents.

The above-described method of controlling the electronic device may be written as computer programs and may be implemented in digital microprocessors that execute the programs using a computer readable recording medium. The method of controlling the electronic device may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

An electronic device may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling an electronic device that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The embodiment is applicable to an electronic device including a recording medium to record an application program for integrally managing clipping contents, a device to execute an application program, a smart phone, a PDA, and a notebook computer.

1. An electronic device comprising:
a display: and
a controller configured to select at least one clipping region from an execution screen having at least one application, configured to extract at least one clipping contents from the at least one clipping region and location information of the at least one clipping region, configured to generate at least one item corresponding configured to the at least one clipping contents, and configured to display the at least one item on a specific region of the display.

2. The electronic device of claim 1, wherein the controller display at least one item corresponding to the at least one clipping contents when receiving a first input with respect to the specific region, and releases display of at least one time corresponding to the at least one clipping contents when receiving a second input with respect to the specific region.

3. The electronic device of claim 1, wherein the controller displays at least one item corresponding to the at least one clipping contents to be overlapped with the specific region on an execution screen of a specific application when the execution screen of the specific application is displayed on the display.

4. The electronic device of claim 1, wherein the controller designates the specific region of the display as a bay-type region formed based on a corner of the display.

5. The electronic device of claim 1, wherein the controller moves at least one item corresponding to the at least one clipping contents to a left side or a right side, and displays at least one item corresponding to the at least one clipping contents which are not displayed on the specific region of the display on the specific region of the display when receiving a left or right movement input with respect to at least one item corresponding the at least one clipping contents displayed on the specific region of the display.

6. The electronic device of claim 1, wherein the at least one item corresponding to the at least one clipping contents comprises at least one of clipping contents, thumbnail information, key contents among the at least one clipping contents, and an icon of an application selecting the at least one clipping contents.

7. The electronic device of claim 1, wherein the controller enlarges and displays the specific clipping contents as a pop-up window when receiving a first input with respect to a specific item corresponding to specific clipping contents among at least one item corresponding to the at least clipping contents.

8. The electronic device of claim 7, wherein the controller performs a shortcut to an execution screen of a specific application corresponding to location information of a specific clipping region including the specific clipping contents, displays the execution screen of the specific application on the display, and displays an indicator on the specific clipping region of the execution screen of the application when receiving a second input with respect to the pop-up window.

9. The electronic device of claim 1, wherein the controller enlarges and displays latest selected clipping contents among clipping contents associated with the specific application when receiving a first input with respect to an icon associated with a specific application among at least one item corresponding to the at least one clipping contents.

10. The electronic device of claim 9, wherein the controller reduces a plurality of clipping contents associated with the specific application to display the reduced clipping contents when receiving a second input with respect to the pop-up window.

11. The electronic device of claim 1, wherein the controller performs a shortcut to an execution screen of a specific application corresponding to location information of a specific clipping region including a latest selected clipping contents among clipping contents associated with the specific application to display the execution screen of the specific application on the display, and displays an indicator on the specific clipping region of the execution screen of the specific application when receiving a first input with respect to an icon associate with a specific application among at least one item corresponding to the at least one clipping contents.

12. The electronic device of claim 1, wherein the controller automatically executes an application to manage the at least one clipping contents when receiving an input to select the at least one clipping region during execution of the at least one application.

13. The electronic device of claim 1, wherein the controller highlights and displays main contents among the specific clipping contents when specific contents included in specific clipping contents are set as the main contents.

14. The electronic device of claim 1, wherein the controller displays a used history with respect to at least one item corresponding to the at least one clipping contents as an indicator when another application uses the at least one clipping contents.

15. The electronic device of claim 1, wherein the controller automatically sets the specific region of the display according to a touch track.

16. The electronic device of claim 1, wherein the controller filters the at least one clipping contents according to a type of specific application and displays an item corresponding to the filtered clipping contents on the specific region of the display when the specific application is executed.

17. An electronic device comprising:
a display: and
a controller configured to store at least one of clipping contents included in a at least one clipping region selected from an execution screen with at least one application, location information of the at least one clipping region, and at least one item corresponding to the at least one clipping contents, configured to filter the at least one stored clipping contents with a preset reference according to a specific application when the specific application is executed, and configured to display an item corresponding to the filtered clipping contents on a specific region of the display when an input item is included in the execution screen of the specific application.

18. The electronic device of claim 17, wherein the controller executes copy and paste functions with respect to the filtered clipping contents upon selection of the filtered clipping contents when the input item of the execution screen of the specific application is edited.

19. A method for controlling an electronic device, the method comprising:
selecting at least one clipping region from an execution screen of a specific application;
extracting at least one clipping contents included in the at least one clipping region and location information of the at least one clipping region through an application to manage at least one clipping contents included in the at least one clipping to generate at least one item corresponding to the at least one clipping contents when receiving an input to select the at least one clipping region during execution of the specific application; and
displaying the generated at least one item to be overlapped with a specific region of the execution screen of the specific application.

20. A method for controlling an electronic device, the method comprising:
storing at least one clipping contents included in at least one clipping region selected from an execution screen with at least one application, location information of the at least one clipping region, and at least one item corresponding to the at least one clipping contents through a first application;
filtering the at least stored clipping contents according to a type of the second application by executing the first application as a back-ground when receiving an execution request of a second application; and
switching an execution screen of the first application to a fore-ground and displaying an item corresponding to the filtered clipping contents on a specific region when an input item is included in an execution screen of the second application.
